(19) United States
(12) Patent Application Publication
(10) Pub. No.: US 2018/0334291 A1
(43) Pub. Date: Nov. 22, 2018

(54) HANDLE FOR BAG, RESULTING BAG, AND METHOD OF MAKING THE SAME

(71) Applicant: Coating Excellence International, LLC, Wrightstown, WI (US)

(72) Inventor: Gary F. Sargin, Green Bay, WI (US)

(73) Assignee: Coating Excellence International, LLC, Wrightstown, WI (US)

(21) Appl. No.: 15/986,090

(22) Filed: May 22, 2018

Related U.S. Application Data
(62) Division of application No. 15/058,798, filed on Mar. 2, 2016, now abandoned.

(51) Int. Cl. B65D 33/08; B31B 70/00; B65D 33/18; B65B 51/02; B65D 30/08; B65B 61/14; B65D 30/20

(52) U.S. Cl. CPC B65D 33/08; B31B 70/00; B65D 33/18; B65D 31/10; B65D 31/04; B65B 61/14; B65B 51/02

(57) ABSTRACT

A bag includes a body with a closed and stepped end, and an opening in the closed end as a handle. A tube having a first panel, a second panel and two side gussets is provided. The tube is foldable inward along a longitudinal fold line on each of the two side gussets. A stepped end is formed. The first panel has a first longitudinal length, the two side gussets have at least one portion having a second longitudinal length, which is longer than the first longitudinal length and shorter than a length of the second panel. The second panel of the tube is folded along a latitudinal fold line between the top line of the first panel and the top line of the tube so as to form the closed end. The opening is cut in the closed end.

### PRIORITY CLAIM AND CROSS-REFERENCE

This application is a divisional of application Ser. No. 15/058,798, filed Mar. 2, 2016.

### FIELD OF THE INVENTION

The disclosure relates to a bag and the method of making the same generally. More particularly, the disclosed subject matter relates to a handle for a bag, the resulting bag, and the method of making the handle and the bag.

### BACKGROUND

Large format bags are used for packaging goods such as human food, pet food, wild bird feed, seeds, agricultural feeds, and fertilizers. These bags are generally difficult to pick up and carry due to their size and bulk. Currently only limited technology is available for applying a handle to one of these format bags. One type of handle applied to these bags includes a rigid plastic handle, which is generally sewn into the end of a bag. However, the bags with these type of handles are associated with high cost, and are also bulky, requiring more space during storage and shipment, compared to the same amount of empty bags without handles.

### SUMMARY OF THE INVENTION

The present disclosure provides a method of making a bag having a handle, and the resulting bag. Such a bag may have a stepped end in some embodiments.

In one aspect, a method for making a bag is provided. In such a method, a tube is provided in some embodiments. The tube comprises a first panel, a second panel having a top line of the tube, and two side gussets (or panels) between the first panel and the second panel. The tube has an open end defined by edges of the first panel, the second panel and the two side gussets. The tube is configured to be foldable inward and expandable outward along a longitudinal fold line (a first fold line) on each of the two side gussets. The tube comprises or is made of a flexible material, for example, polymer(s) or paper. The tube may also have a multi-wall structure. In some embodiments, the tube comprises a woven inner layer.

A stepped end is formed adjacent to the open end of the tube. In the stepped end, the first panel has a top line of the first panel with a first longitudinal length, the two side gussets have at least one portion having a second longitudinal length, which is longer than the first longitudinal length and shorter than a length of the second panel. All the length values are relative to a bottom line of the tube. The stepped end may be formed through trimming. For example, the first panel is trimmed to the top line of the first panel with the first longitudinal length, and the two side gussets are trimmed to have the at least one portion having the second longitudinal length. In some embodiments, the two side gussets in the stepped end comprises at least two step portions, for example, a first portion connected to the first panel and a second portion connected to the second panel. The first portion has a shorter longitudinal length than the second portion in some embodiments.

An adhesive may be applied onto at least one portion of the tube adjacent to the open end, for example, after the stepped end is formed. The second panel of the tube is folded along a latitudinal fold line (i.e. a second fold line) so as to form a closed end, wherein the second fold line is between the top line of the first panel and the top line of the tube. After the folding step, the top line of the tube is at or below the top line of the first panel after folded. The adhesive applied facilitates the formation of the closed end, and is applied onto at least one portion within the folded area.

In some embodiments, such a method further comprises a step of cutting the closed end so as to form an opening defined by the closed end and configured to function as a handle for the bag.

In some embodiments, the present disclosure also provides a method of making a bag, in which a tube having a stepped end adjacent to an open end of the tube is provided. Such a tube having a stepped end has a structure as described above. In some embodiments, the two side gussets in the stepped end comprises at least two step portions, a first portion connected to the first panel and a second portion connected to the second panel, wherein the first portion has a shorter longitudinal length than the second portion. As described above, such a method may further comprise the steps of applying an adhesive onto at least one portion of the tube adjacent to the open end; and folding the second panel of the tube along a latitudinal fold line (i.e. a second fold line) so as to form a closed end. The second fold line is between the top line of the first panel and the top line of the tube, and the top line of the tube is at or below the top line of the first panel after folded. Such a method further comprises a step of cutting the closed end so as to form an opening defined by the closed end and configured to function as a handle for the bag.

In another aspect, a bag with a handle is provided. The bag can be made using the method described above. The bag comprises a body with a closed end having a stepped structure, and an opening defined by the closed end and configured to function as a handle for the bag. The body comprises a first panel, a second panel having a top line of the body, and two side gussets between the first panel and the second panel. The body is configured to be foldable inward and expandable outward along a longitudinal fold line (i.e. a first fold line) on each of the two side gussets. The first panel has a top line of the first panel with a first longitudinal length. The two side gussets have at least one portion having a second longitudinal length. The second longitudinal length is longer than the first longitudinal length and shorter than a length of the second panel. These length values are relative to a bottom line of the tube when the body is in an open position. In the closed end the second panel is folded along a latitudinal fold line (i.e. a second fold line) between the top line of the first panel and the top line of the body. The top line of the body is at or below the top line of the first panel in the bag.

The bag further comprises an adhesive disposed inside the closed end. The body is made from the tube described above, and comprises a flexible material such as polymer or paper. The body may have a multi-wall structure such as a woven inner layer. The two side gussets in the closed end may also comprise at least two step portions, for example, a first portion connected to the first panel and a second portion connected to the second panel, wherein the first portion has a shorter longitudinal length than the second portion.

### BRIEF DESCRIPTION OF THE DRAWINGS

The present disclosure is best understood from the following detailed description when read in conjunction with the accompanying drawings. It is emphasized that, according to common practice, the various features of the drawings are not necessarily to scale. On the contrary, the dimensions of the various features are arbitrarily expanded or reduced for clarity. Like reference numerals denote like features throughout specification and drawings.

FIG. 1 is an isometric view illustrating an exemplary tube having a first panel and a second panel, and side gussets, wherein the tube is adapted for making a bag, in accordance with some embodiments.

FIG. 2 is an isometric view illustrating the tube of FIG. 1, wherein the side gussets are folded inward along longitudinal creases or folds.

FIG. 3A is a plan view illustrating an exemplary tube manufactured with a stepped end on the first panel and the second panel in accordance with some embodiments.

FIG. 3B is an isometric view illustrating the tube of FIG. 3A.

FIG. 4A is a plan view illustrating the structure of the tube of FIG. 3A and FIG. 3B after an adhesive is applied.

FIG. 4B is an isometric view illustrating the tube of FIG. 4A.

FIG. 5 is a plan view illustrating the structure of the tube of FIG. 4A after folded and sealed in accordance with some embodiments.

FIG. 6 is a plan view illustrating an exemplary bag having a handle after the tube of FIG. 5 is cut in accordance with some embodiments.

FIG. 7 is an isometric view illustrating a front end of an exemplary bag having a handle in accordance with some embodiments.

FIG. 8 is a flowchart illustrating an exemplary method of making an exemplary bag having a handle in accordance with some embodiments.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

For purposes of the description hereinafter, it is to be understood that the embodiments described below may assume alternative variations and embodiments. It is also to be understood that the specific articles, compositions, and/or processes described herein are exemplary and should not be considered as limiting.

The present disclosure provides a method of making a bag having a handle, and the resulting bag. Such a bag may have a stepped end in some embodiments. The present disclosure provides a handle design incorporated into a format bag including but not limited to a multi-wall paper or woven poly bag. A poly bag refers to a bag comprising a polymer material such as polyolefin such as polyethylene and polypropylene. Such a bag with such a handle design can be used as a large format bag for packaging goods such as human food, pet food, wild bird feed, seeds, agricultural feeds, and fertilizers. The resulting bag is easy for picking up and carrying despite its size and load with goods. The method also offers flexibility in processing. For example, such a handle design can be made before or after such a bag is packed and sealed with goods.

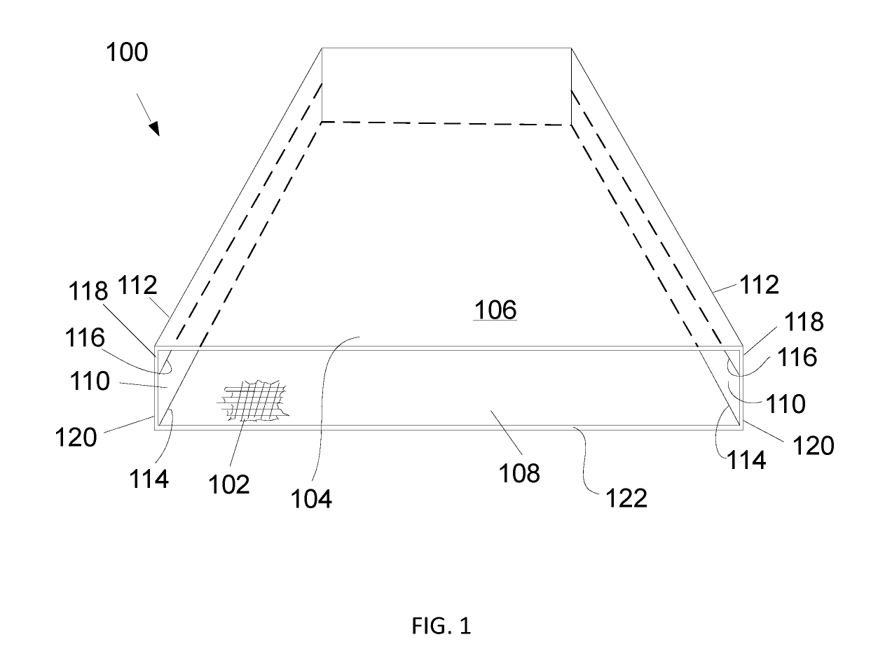

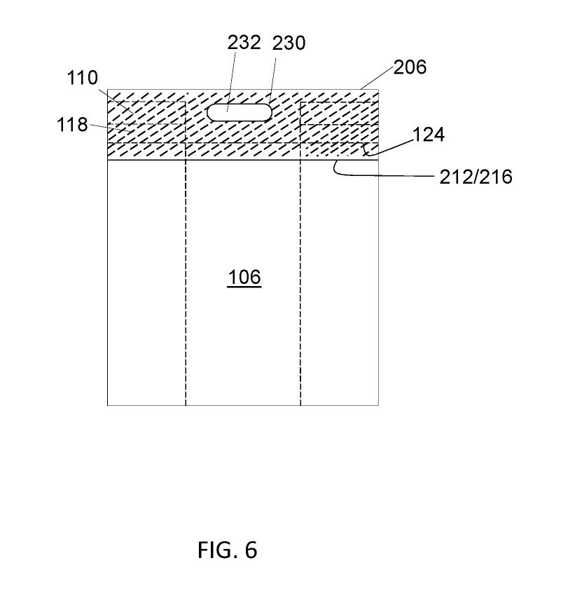

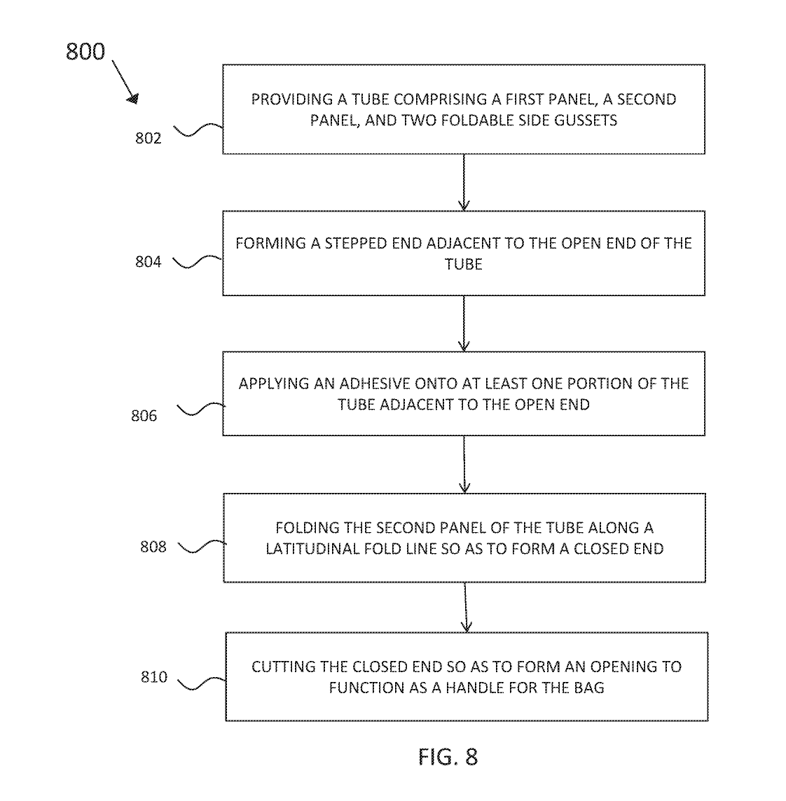

In FIGS. 1-7, like items are indicated by like reference numerals, and for brevity, descriptions of the structure, provided above with reference to the previous figures, are not repeated. The exemplary method 800 described in FIG. 8 is described with reference to the exemplary structure described in FIGS. 1-7.

Referring to FIG. 8, at step 802, an exemplary tube 100 is provided.

Referring to FIG. 1, exemplary tube 100 having at least one open end is used in some embodiments. Tube 100 comprises a first panel 106, a second panel 108, a first side panel or gusset 110 and a second side panel or gusset 110 between the first and second panels 106, 108. In some embodiments, the first panel 106 refers to a front panel of a bag while the second panel 108 refers to a back panel of the bag. Alternatively, the first panel 106 refers to a back panel of the bag while the second panel 108 refers to a front panel of the bag.

Side edges 112, 112 of the first panel 106 are connected to the first side gusset 110 and, the second side gusset 110, respectively. Side edges 114, 114 of the second panel 108 are connected to the first side gusset 110 and the second side gusset 110, respectively. The first side gusset 110 and the second side gusset 110 are foldable inward along longitudinal creases or folds 116, 116 (i.e. first fold lines) to flatten the tube. The gussets 110, 110 fold or crease along the side edges 112, 112 and the side edges 114, 114. Each side gusset 110 comprises a first section 118 connected with the first panel 106, and a second section 120 connected with the second panel 108. So tube 100 is configured to be foldable inward and expandable outward along the longitudinal fold line 116, 116 on each of the two side gussets.

Tube 100 has at least one open end 122 defined and encircled by the first panel 106, the second panel 108 and the side gussets 110, 110. In some embodiments, tube 100 has two open ends, each of which is defined by the first panel 106, the second panel 108 and the side gussets 110, 110. The tube has an open end defined by edges of the first panel 106, the second panel 108 and the two side gussets 110. This open end is the top or front end of the bag for the handle to be made. In some embodiments, both ends of the tube 100 can be open. The bottom end of the bag to be made can be sealed or open before or after the top end is sealed.

Tube 100 comprises or is made of a flexible polymeric material such as at least one polymeric material, paper, and any combination thereof. The tube may also have a multi-wall structure. In some embodiments, the tube comprises a woven inner layer. In some embodiments, tube 100 is made of a flexible polymeric material, or paper. The flexible polymeric material may have a woven or solid structure of one or multiple layers. Examples of a suitable polymer include but are not limited to polyethylene, polypropylene, nylon, a copolymer, a blend, and any other suitable polymer or combination thereof. Suitable paper may have a multiple-walled structure, and may be coated with a layer of polymer.

An embodiment of tube 100 is formed as a laminated tube 100 that has a woven inner layer 102, a portion of which is illustrated to comprise a tight basket weave of thin, flexible, elongated strips of a polymeric material, for example, polyethylene, polypropylene, nylon, a copolymer, a blend, and any other suitable polymer or combination thereof. The inner layer 102 advantageously comprises a woven seamless tube, that is highly flexible due to the weave. The laminated tube 100 has at least one outer layer 104 of a printable nonwoven polymeric material, for example, polypropylene film that is capable of being printed with graphics using water based pigments or solvent based pigments.

In an embodiment, outer layer 104 is reverse printed on an inside surface of a first polypropylene film. In another embodiment, a second layer of polypropylene film is laminated to the first polypropylene film, with the printed surface between the first and second layers of polypropylene film. Alternatively, the second layer of polypropylene film can be printed with the graphics.

After printing, outer layer 104, and each second layer of polypropylene film, if present, and woven inner layer 102 are laminated, for example, by applying a solventless adhesive material or solvent based adhesive material between the layers to be laminated, and applying heat and pressure to laminate each outer layer 104, second layer and the inner layer 102 and form the continuous laminated tube 100. The woven inner layer 102 can be seamless tubular, while the outer layer 104 and each second layer of polypropylene film can overlap and form a lengthwise closed seam, that is adhesively sealed shut to form a seamed tubular construction, further described by U.S. Pat. No. 8,227,062.

Alternative embodiments of tube 100 are fabricated with one or more nonwoven polypropylene films to provide a nonwoven inner layer 102 and a nonwoven outer layer 104.

Further embodiments of the tube 100 comprise, a seamless blown tube, a seamless woven tube and a tube manufactured from flat sheets laminated together to form a seamed tubular construction. Embodiments of the tube comprise, a seamless blown tube, a seamless woven tube and a tube manufactured from flat sheets laminated together to form a seamed tubular construction. Further, a particular embodiment of a tube includes a seamless woven tube of polypropylene or other polyolefin material, which is desired for its tensile strength in order to package and store heavy contents in granular form, such as, dog food, cereals, grains and construction materials.

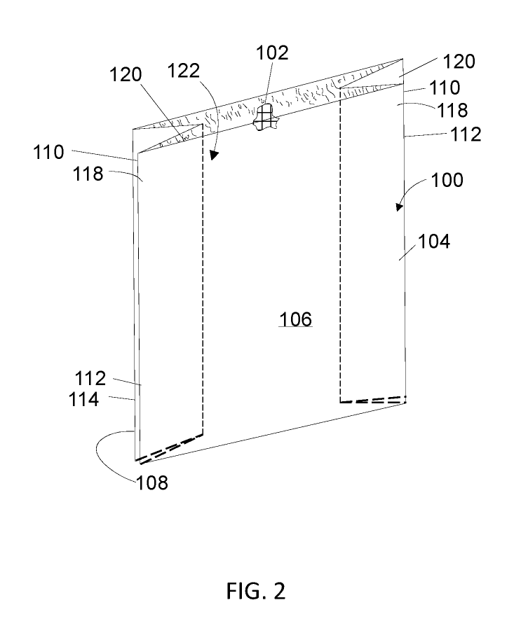

In FIG. 2, respective first sections 118, 118 of the side gussets 110, 110 are adjacent to the first panel 106. Respective second sections 120, 120 of the side gussets 110 are adjacent to the second panel 108. The side gussets 110 are folded along the folds 116. The first sections 118 and the second sections 120 fold inwardly along the folds 116, and are in an inwardly folded orientation between the first panel 106 and the second panel 108 while the tube 100 is flat. Each side gusset 110 is adapted to unfold outwardly from between the first panel 106 and the second panel 108 to expand the bag interior. At least one end 122 is open.

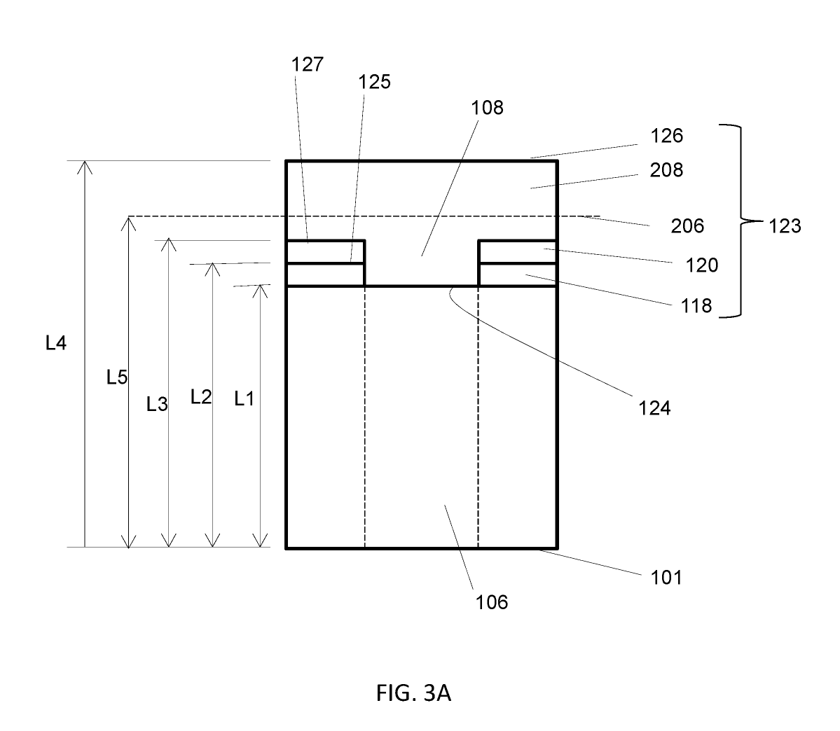

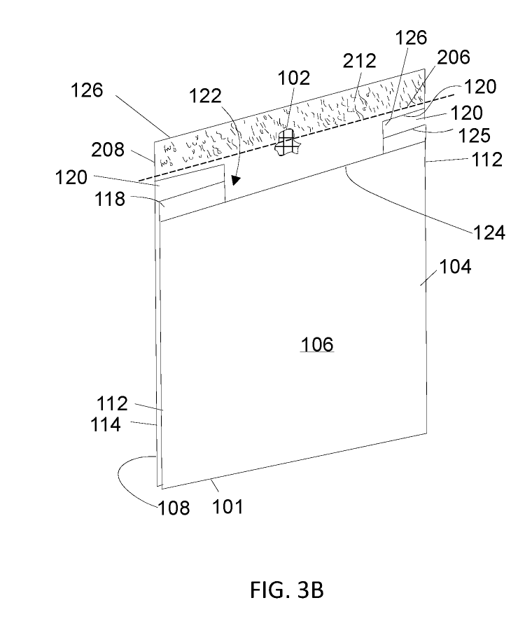

Referring to FIG. 8, at step 804, a stepped end is formed adjacent to the open end 122 of the tube 100. An exemplary structure is illustrated in FIGS. 3A and 3B. The stepped end may be formed through trimming, or any other suitable method. A method is disclosed in U.S. Pat. No. 9,073,281, which is incorporated by reference herein in its entirety.

Referring to FIGS. 3A and 3B, tube 100 is made with a stepped, or step cut construction at the open end 122, wherein a portion of the first panel 106 is removed by severing, cutting or hot knife, and wherein the first panel 106 is made shorter than a longer portion 208 of the second panel 108 at the open end. Further, a portion of each of the side gussets 110, 110 is removed, wherein the side gussets are made longer than the first panel 106 and shorter than the second panel 108. The longer portion 208 provides a foldable flap portion on the second panel 108. As a result, a stepped end 123 is formed on the tube 100. Although the stepped end 123 is disclosed on an embodiment of the tube 100 in FIGS. 3A and 3B, the stepped end 123 can be made on any embodiment of a tube of flexible polymeric material intended for making a bag.

In the stepped end, the first panel 106 has a top line 124 of the first panel with a first longitudinal length (L1). The two side gussets 110 have at least one portion (e.g., at the edges 125 or 127) having a second longitudinal length (L2 or L3), which is longer than the first longitudinal length (L1) and shorter than a length of the second panel (L4) from a top edge 126. All the length values are relative to a bottom line 101 of tube 100.

The stepped end may be formed through trimming. For example, the first panel 106 is trimmed to the top line 124 of the first panel 106 with the first longitudinal length (L1), and the two side gussets 110 are trimmed to have the at least one portion having the second longitudinal length (L2 or L3). In some embodiments, as shown in FIGS. 3A and 3B, the two side gussets 110 in the stepped end comprise at least two step portions (portions 118 and 120 having edges 125 or 127, respectively), for example, a first portion 118 (with edge 125) connected to the first panel 106, and a second portion 120 (with edge 127) connected to the second panel 108. The first portion 118 has a shorter longitudinal length (L2) than the length (L3) of the second portion 120 in some embodiments.

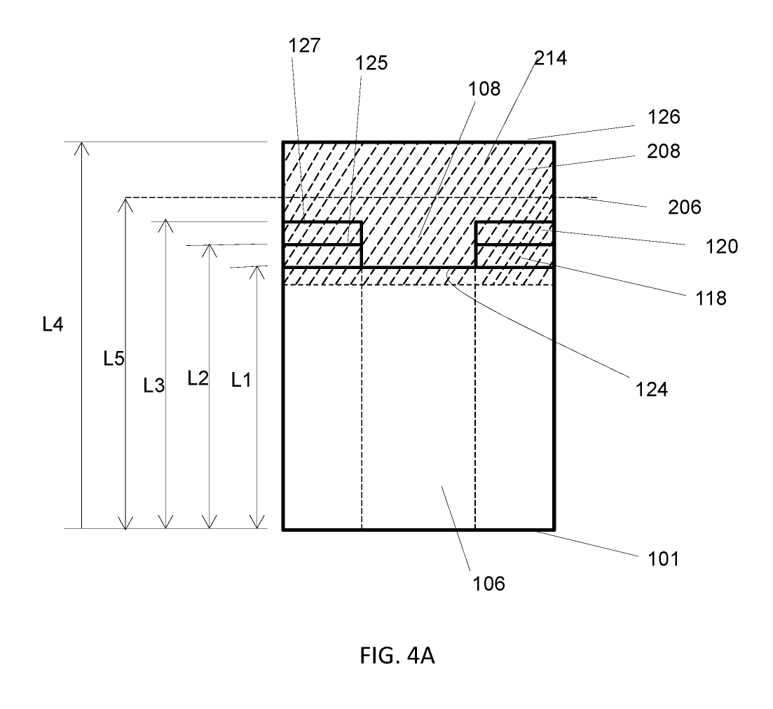

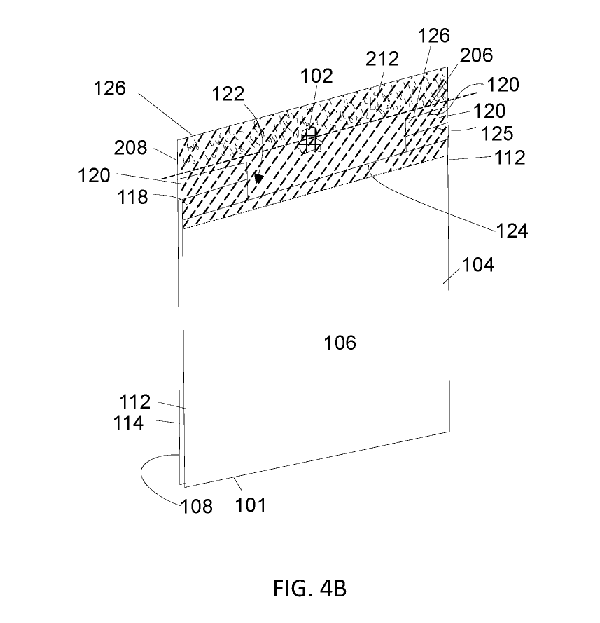

Referring back to FIG. 8, at step 806, an adhesive 214 may be applied onto at least one portion of the tube 100 adjacent to the open end 122, for example, after the stepped end is formed. Resulting structure is shown in FIGS. 4A and 4B. The adhesive can be any adhesive curable with heat, light or moisture, in the form of liquid or paste. The adhesive can be also polymer melt. It does not contain any solvent in some embodiments.

One suitable adhesive material for heat sealing polyolefin films of the tube 100 comprises a water based emulsion of triethylamine adhesive commercially available as AQUAGRIP® 19566F, manufactured by Bostik, Inc., 11320 Watertown Plank Road, Wauwatosa, Wis. 53226 USA. Another embodiment of a hot melt adhesive for heat sealing polyolefin films of the tube 100 comprises a hot melt adhesive H9463 available commercially from Bostik, Inc. Wauwatosa, Wis. 53226, USA. Another embodiment of a hot melt adhesive for heat sealing polyolefin films of the tube 100 comprises a hot melt adhesive H9477 Generation II of H9463, now or soon to be available commercially from Bostik, Inc., Wauwatosa, Wis. 53226, USA, wherein the adhesives per se form no part of the present invention separate from being a structural component of the tubes disclosed herein.

Another embodiment of a suitable adhesive material for heat sealing polyolefin films of the tube 100 comprises an aqueous based dispersion or emulsion as an opaque liquid or fluid of an ethylene copolymer or ethylene copolymers, butyl acetate and acetaldehyde, which is commercially available as the product name ROBOND™ HS 37-140 adhesive material manufactured by Rohm and Haas Company, 100 Independence Mall West, Philadelphia, Pa. 19106-2399 USA. Another embodiment of a suitable adhesive material for heat sealing polyolefin films of the tube 100 comprises an aqueous based dispersion or emulsion as an opaque liquid or fluid, including an ionomer dispersion in water, based upon Surlyn® ionomer resin, and which can be diluted or thickened or crosslinked for enhanced properties, and which is commercially available as the product name ADCOTE™ 37-220 Heat Seal Coating, manufactured by Rohm and Haas Company, 100 Independence Mall West, Philadelphia, Pa. 19106-2399 USA, wherein the adhesives per se form no part of the present invention separate from being a structural component of the tubes disclosed herein.

Another embodiment of a suitable adhesive material for heat sealing polyolefin films of the tube 100 comprises an aqueous based dispersion or emulsion as an opaque liquid or fluid, including water, acrylic polymer; polyester polyurethane resin, formaldehyde, ammonium hydroxide, alumina and further including ammonia as a combustion product, which is commercially available as the product name NWC 23526K (and NWC 23526KC) FDA WATER BASE HEAT SEAL FOR POLYWOVEN™ adhesive material, product code 728575, manufactured by ASHLAND Inc., P.O. Box 2219, Columbus, Ohio 43216, USA, wherein the adhesive per se forms no part of the present invention separate from being a structural component of the tubes disclosed herein.

Another embodiment of a suitable adhesive material for heat sealing polyolefin films of the tube 100 comprises a liquid state, acrylated epoxy based adhesive commercially available as the product name, VERSA-WELD™ 70-7879, adhesive material manufactured by Henkel Corporation, P.O. Box 6500; 10 Finderline Avenue, Bridgewater, N.J. 08807 USA, wherein the adhesive per se forms no part of the present invention separate from being a structural component of the tubes disclosed herein.

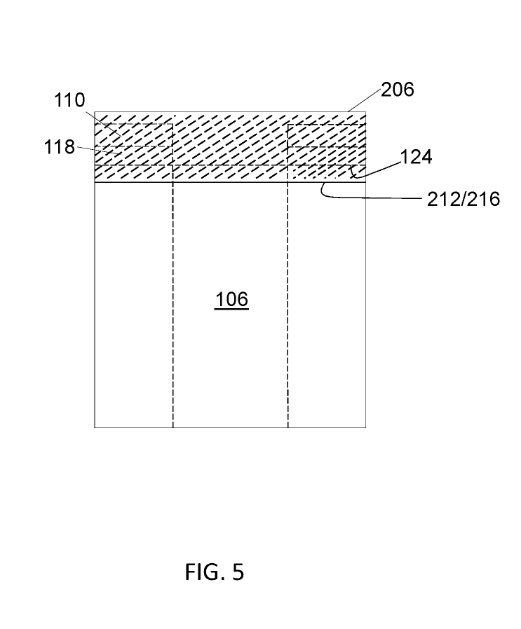

At step 808, the second panel 108 of the tube 100 is folded along a latitudinal fold line (a second fold line) 206 (shown in FIGS. 3A and 3B) so as to form a closed end. The resulting structure is shown in FIG. 5. Referring to FIGS. 3A and 3B, the second fold line is between the top line 124 of the first panel 106 and the top line 126 of the tube 100 (or the second panel 108). After the folding step, the top line 126 of the second panel 108 is at or below the top line 124 of the first panel 106 after folded. The adhesive 214 applied facilitates the formation of the closed end, and is applied onto at least one portion within the folded area.

Referring to FIG. 8, at step 801, the closed end is cut so as to form an opening 230 defined by the closed end and configured to function as a handle for the bag. In some embodiments, the material from the closed end at the opening 230 is still connected with the bag so as to form a flap 232.

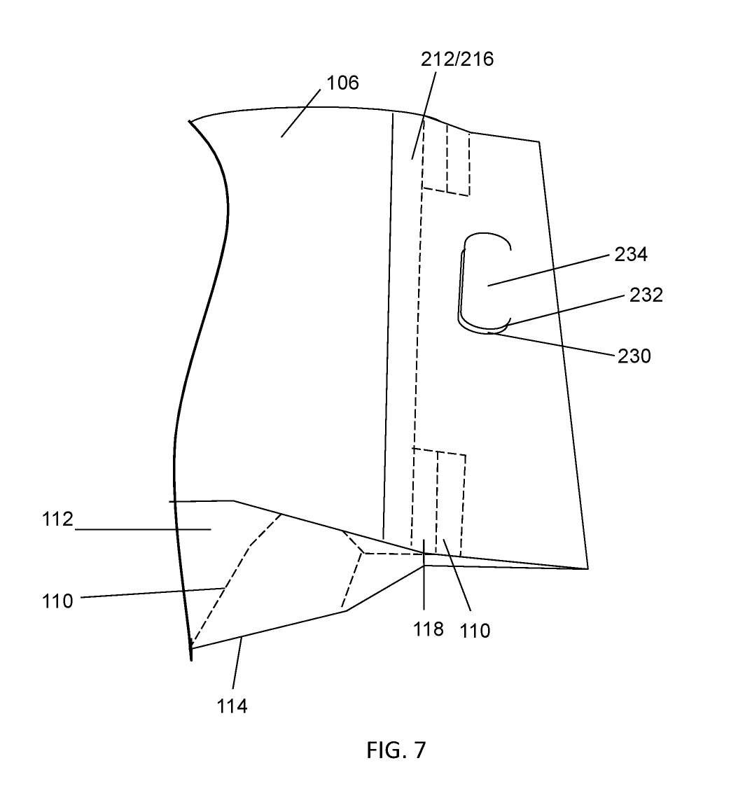

As shown in FIG. 7, an exemplary bag with a handle 230 is provided. The bag can be made using the method described above. The bag comprises a body 100 with a closed end having a stepped structure, and an opening 230 defined by the closed end and configured to function as a handle for the bag. The body 100 comprises a first panel 106, a second panel 108 having a top line of the body, and two side gussets 110 between the first panel 106 and the second panel 108. The body 100 is configured to be foldable inward and expandable outward along a longitudinal fold line 116 on each of the two side gussets 110. The first panel 106 has a top line of the first panel 124 with a first longitudinal length (L1). The two side gussets 110 have at least one portion having a second longitudinal length (L2, L3). The second longitudinal length (L2 or L3) is longer than the first longitudinal length (L1) and shorter than a length (L4) of the second panel. These length values are relative to a bottom line 101 of the tube when the body is in an open position. In the closed end the second panel 108 is folded along a latitudinal fold line (i.e. a second fold line) 206 between the top line 124 of the first panel 106 and the top line 126 of the second panel 108. The top line 126 is at or below the top line 124 of the first panel 106 in the bag.

The bag further comprises an adhesive 214 disposed inside the closed end. The body 100 is made from the tube described above, and comprises a flexible material such as polymer or paper. The body may have a multi-wall structure such as a woven inner layer. The two side gussets 110 in the closed end may also comprise at least two step portions, for example, a first portion 118 with edges 125 connected to the first panel 106 and a second portion 120 with edges 127 connected to the second panel 108, wherein the first portion has a shorter longitudinal length than the second portion.

The tube 100 also has a bottom end, which can be open or sealed. Method 800 may comprise a step of closing or sealing the bottom end. The bottom can be pinched closed, sewn, slide zipped, or closed in any suitable method. This step can be performed before or after any step described. Goods can be packed into the bag before or after any time. For example, In some embodiments, a tube having a stepped end adjacent to an open end of the tube (as shown in FIGS. 3A and 3B) is provided. Such a tube having a stepped end has a structure as described above. Steps 806 and 808 can be performed after goods are packed into the tube. Alternatively, steps 806, 808 and 810 can be performed before goods are packed into the tube. The goods can be packed into the tube from the open bottom end of the tube.

Although the subject matter has been described in terms of exemplary embodiments, it is not limited thereto. Rather, the appended claims should be construed broadly, to include other variants and embodiments, which may be made by those skilled in the art.

What is claimed is:

1. A method of making a bag, comprising:
providing a tube comprising a first panel, a second panel having a top line of the tube, and two side gussets between the first panel and the second panel, the tube having an open end defined by the first panel, the second panel and the two side gussets, and configured to be foldable inward along a longitudinal fold line on each of the two side gussets;
forming a stepped end adjacent to the open end of the tube, wherein the first panel has a top line of the first panel with a first longitudinal length, the two side gussets have at least one portion having a second longitudinal length, the second longitudinal length is longer than the first longitudinal length and shorter than a length of the second panel, and the first longitudinal length, the second longitudinal length and the length of the second panel are relative to a bottom line of the tube;
applying an adhesive onto at least one portion of the tube adjacent to the open end; and
folding the second panel of the tube along a latitudinal fold line so as to form a closed end, wherein the latitudinal fold line is between the top line of the first panel and the top line of the tube, and the top line of the tube is at or below the top line of the first panel after folded.

2. The method of claim 1, further comprising:
cutting the closed end so as to form an opening defined by the closed end and configured to function as a handle for the bag.

3. The method of claim 1, wherein the tube comprises a flexible material.

4. The method of claim 1, wherein the tube is made of polymer or paper.

5. The method of claim 1, wherein the tube has a multi-wall structure.

6. The method of claim 1, wherein the tube comprises a woven inner layer.

7. The method of claim 1, wherein the stepped end adjacent to the open end of the tube is formed through trimming, wherein the first panel is trimmed to the top line of the first panel with the first longitudinal length, and the two side gussets are trimmed to have the at least one portion having the second longitudinal length.

8. The method of claim 1, wherein the two side gussets in the stepped end comprises at least two step portions, a first portion connected to the first panel and a second portion connected to the second panel, wherein the first portion has a shorter longitudinal length than the second portion.

9. A method of making a bag, comprising:
providing a tube having a stepped end adjacent to an open end of the tube, the tube comprising a first panel, a second panel having a top line of the tube, and two side gussets between the first panel and the second panel, the tube configured to be foldable inward along a longitudinal fold line on each of the two side gussets, wherein the first panel has a top line of the first panel with a first longitudinal length, the two side gussets have at least one portion having a second longitudinal length, the second longitudinal length is longer than the first longitudinal length and shorter than a length of the second panel, and the first longitudinal length, the second longitudinal length and the length of the second panel are relative to a bottom line of the tube;
applying an adhesive onto at least one portion of the tube adjacent to the open end; and
folding the second panel of the tube along a latitudinal fold line so as to form a closed end, wherein the latitudinal fold line is between the top line of the first panel and the top line of the tube, and the top line of the tube is at or below the top line of the first panel after folded.

10. The method of claim 9, wherein the tube is made of polymer or paper, and comprises a woven inner layer.

11. The method of claim 9, wherein the two side gussets in the stepped end comprises at least two step portions, a first portion connected to the first panel and a second portion connected to the second panel, wherein the first portion has a shorter longitudinal length than the second portion.

12. The method of claim 9, further comprising:
cutting the closed end so as to form an opening defined by the closed end and configured to function as a handle for the bag.
